(19) United States
(12) Patent Application Publication
(10) Pub. No.: US 2010/0319546 A1
(43) Pub. Date: Dec. 23, 2010

(54) RAPPING DEVICE FOR PRECIPITATION ELECTRODES IN ELECTROSTATIC SEPARATORS

(75) Inventors: Armin Burau, Duisburg (DE); Martin Zinselmeyer, Mulheim (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Salzgitter Mannesmann GmbH, Salgitter (DE)

(21) Appl. No.: 12/677,965

(22) PCT Filed: Sep. 11, 2008
(86) PCT No.: PCT/DE2008/001555

§ 371 Date: Mar. 12, 2010

(30) Foreign Application Priority Data
Sep. 14, 2007 (DE) 10 2007 044 838.6

(51) Int. Cl. B03C 3/76

(52) U.S. Cl. 96/37

(57) ABSTRACT

The invention relates to a device for rapping a row of collector electrodes in an electrostatic precipitator, the collector electrodes consisting of strip plates suspended from their upper ends with respect to their longitudinal extension.

The aim of the invention is to provide a device for rapping a row of collector electrodes which guarantees an even supply of impact energy to the electrode plates and allows a high cleaning efficiency during rapping and a free thermal expansion in the longitudinal direction of the plates.

This aim is achieved in that a gap is defined between the side of every collector electrode facing away from the rapping device and the subsequent anvil. An elastic spring element having a predetermined spring rate is arranged in said gap and is connected only on one side, either to the collector electrode or to the anvil, and is suitable to allow a substantially free oscillation of the collector electrodes between the anvils after an impact momentum.

The invention relates to a device for rapping a row of precipitation electrodes in an electrostatic separator according to the preamble of claim 1.

Electrostatic separators are used, for example, in dust removal systems of sintering machines.

With electrostatic separation, the dust originating from the exhaust gases precipitates and is collected on the electrodes. The precipitated dust must be removed from the electrodes in regular intervals to keep the separation efficiency of the electrostatic separator high. Such rapping device is disclosed, for example, in EP 0 398 476 B1.

The precipitation electrodes of this rapping device consist of lamellar plates arranged vertically in a row and suspended from their top ends. A row can have up to 10 precipitation electrodes.

The bottom ends of the lamellar plates are guided in a ladder-type frame configured as a rapping rod between cross members configured as anvils. The impact-side ends of the precipitation electrodes are here fixedly connected with the corresponding impact-side anvils by an elastic element.

The precipitated dust is removed from the electrodes by applying by way of the rapping rod with a hammer to one side to the row of electrodes an impact-like impulse.

In an ideal situation, oscillations having the same impulse strength are simultaneously introduced in the precipitation electrodes, causing the precipitated dust to detach from the electrode surface and to drop down.

The rapping efficiency depends significantly on the energy transmitted to the individual precipitation electrodes. However, the energy introduced into the individual electrodes is frequently quite heterogeneous, i.e., the energy introduced into the individual plates decreases strongly towards the end of the row of electrodes, so that removal of the dust is insufficient. This is also the case, for example, when the precipitation electrodes have no contact at all or only a loose contact with the corresponding anvils.

The intent is here to make the energy transfer into the individual electrode plates of the known rapping device more uniform and to increase the cleaning efficiency by fixedly connecting the bottom end of the precipitation electrodes with the anvil by way of an elastic element.

This rapping device has the disadvantage that due to the fixed connection between the precipitation electrode and the anvil, the electrode is no longer able to post-oscillate in the guide of the rapping rod, but instead comes to rest immediately after the impact-like impulse is introduced.

Experiments have shown that although the impulse energy is more uniformly introduced during the rapping process, the overall cleaning efficiency is reduced compared to precipitation electrode plates having supports that permit oscillations.

Another disadvantage is that the interposed elastic element dampens the impact-like impulse introduced in the precipitation electrode, preventing introduction of the full impulse energy into the electrodes, which also results in a less than optimal cleaning efficiency.

Disadvantageously, a free thermal expansion of the precipitation electrodes in the longitudinal direction is also inhibited, because the plates are clamped at both their top and bottom ends. This can cause the plates to bulge during operation, resulting in reduced separation efficiency and, in extreme situations, causing a short circuit.

It is therefore an object of the invention to provide a device for rapping a row of precipitation electrodes, which ensures, on one hand, uniform introduction of the impulse energy into the electrode plates and, on the other hand, also a high cleaning efficiency during the rapping process and an unimpeded thermal expansion in the longitudinal direction of the plates.

This object is solved by the preamble in conjunction with the characterizing features of claim 1. Advantageous embodiments are recited in the dependent claims.

According to the teachings of the invention, the rapping device of the invention is characterized in that between the side of each precipitation electrodes facing away from the impact and the following anvil a gap is provided, wherein an elastic spring element with a predetermined spring constant is arranged in the gap, wherein the elastic spring element is connected only on one side either with the precipitation electrodes or the anvil, so as to enable substantially unobstructed oscillation of the precipitation electrodes between the anvils and a return of the precipitation electrodes to their rest position after the oscillation has decayed.

The rapping device of the invention obviates the disadvantages of the conventional rapping device, whereby in addition to efficient, i.e., undamped and direct, introduction of the impulse energy into the electrodes, the electrodes are allowed to oscillate, thereby optimizing the cleaning efficiency of the reciprocation electrodes.

An unimpeded thermal expansion in the longitudinal direction of the plates is permitted, which eliminates a reduction in the efficiency due to bulging of the plates.

The rapping rod is constructed so that the spring elements are attached to the respective anvil on the side of the precipitation electrodes facing away from the impact, and with the spring elements pressing the precipitation electrodes against the corresponding impact-side anvil with an elastic spring force having a small pretension.

In this way, the impact impulse can be introduced into the precipitation electrodes without damping loss.

The spring constant must be dimensioned so that the precipitation electrodes are pressed against the impulse-side anvil only with a small spring force, so that the electrodes can effectively freely oscillate when the impact impulse is introduced.

The impact impulse pushes the precipitation electrode away from the anvil, thereby compressing the spring element on the opposite anvil which then again moves the precipitation electrode to the impact-side anvil under the spring force, where it again receives a impact impulse to continue the cleaning process and hence increase the efficiency.

According to the invention, the spring element is a substantially V-shaped leaf spring, which consists substantially of two legs enclosing an angle. One leg is curved and the other leg is straight, wherein the curved leg advantageously contacts, or is connected to, the precipitation electrode under spring tension in the rest position and the straight leg advantageously contacts, or is connected to, the anvil.

In an advantageous embodiment, the spring element is clipped to the anvil to facilitate exchange of worn or defect spring elements.

Additional features, advantages and details of the invention are disclosed in the following description.

It is shown in:

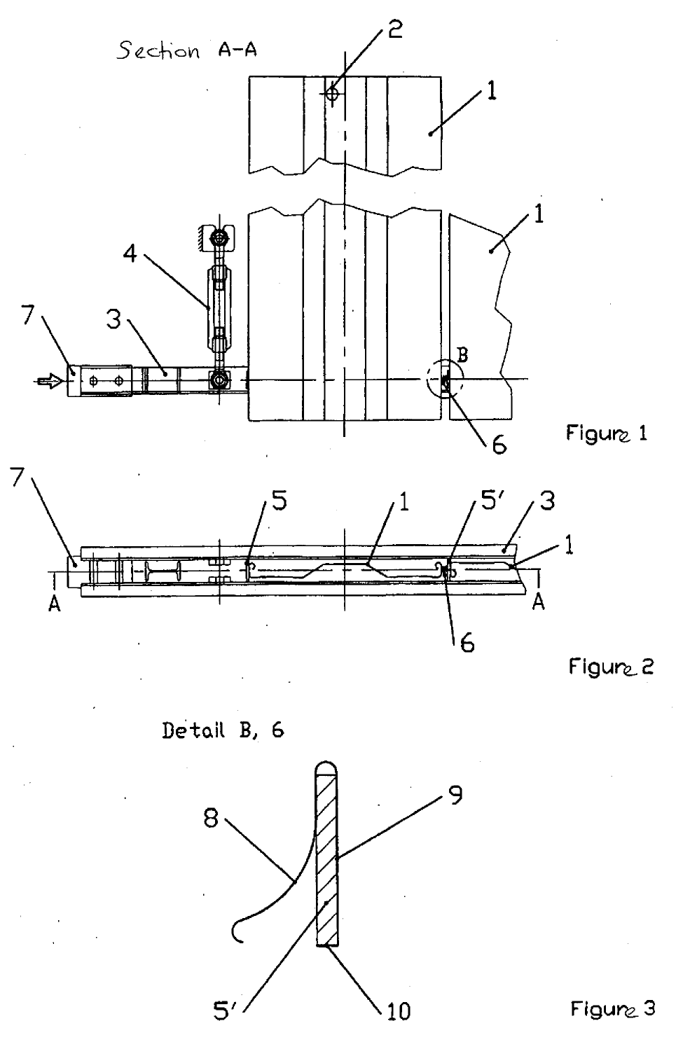

FIG. 1 a schematic diagram of a rapping device according to the invention,

FIG. 2 a cross-sectional view of FIG. 1, and

FIG. 3 a diagram showing details of a spring element.

FIG. 1 shows a schematic diagram of a rapping device according to the invention for electrostatic cleaning of precipitation electrodes.

The precipitation electrode 1, represented by a row of sequentially arranged electrodes, is suspended eccentrically from its top end by way of an opening 2. The mounting suspension is constructed such that the precipitation electrode 1 is supported therein for rotation.

The free bottom end of the precipitation electrode 1 is guided in a ladder-shaped rapping rod 3 which has anvils 5, 5′ forming cross members (FIG. 2). The rapping rod 3 is attached on a mounting suspension 4 which holds the rapping rod in a substantially horizontal position.

The precipitation electrode 1 guided between the anvils 5, 5′ is supported by the eccentric mounting suspension in such a way that the electrode 1 makes permanent contact with the impulse-side anvil 5 in the rest position.

According to the invention, a gap is provided between the precipitation electrode 1 and the anvil 5′ arranged on the side facing away from the impact. A spring element 6 (illustrated here symbolically as a coil spring) is arranged in the gap. Only on one side of the spring element 6 is attached on the anvil 5′. In the rest position, the spring element 6 presses the precipitation electrode 1 with only a slight spring force against the impact-side anvil 5. The anvil 5′ of the respective precipitation electrode 1 facing away from the impact operates as a impact anvil for the respective following electrode.

The one-sided attachment on the anvil 5′ allows an unimpeded longitudinal expansion of the precipitation electrode 1 when the temperature increases.

When the precipitation electrode 1 is cleaned, the impact impulse (depicted with an arrow in the diagram in FIG. 1) of the unillustrated hammer strikes a strike plate 7 which transmits the impulse by way of the anvil 5 directly onto the front surface of the abutting precipitation electrode 1 without damping loss.

The precipitation electrode 1 is repelled from the anvil 5 by the impact impulse and oscillates towards the anvil 5′, elastically compressing the spring element 6 and introducing an oscillation of the precipitation electrode 1 in the opposite direction. The spring constant is dimensioned so as to provide only a small damping of the oscillation and a strong cleaning effect.

FIG. 3 shows the spring element 6 in the detailed view B indicated in FIG. 1. According to the invention, the spring element 6 is attached on the anvil 5′ facing away from the impact. The spring element 6 is implemented as a leaf spring with one curved leg 8 and a straight leg 9. According to the invention, the leaf spring 6 is constructed so that it can be easily clipped on the anvil 5′, allowing easy exchange.

To prevent the leaf spring 6 from slipping off the anvil 5′, the free end of the straight leg 9 has an angled leg 10 which clasps the front of the anvil 5′.

### LIST OF REFERENCES SYMBOLS

No. Designation
1 Precipitation electrode
2 Opening
3 Rapping rod
4 Mounting suspension
5, 5′ Anvil
6 Spring element
7 Strike plate
8 Curved leg
9 Straight leg
10 Angled leg

1.-7. (canceled)

8. A device for rapping a row of vertically suspended precipitation electrodes in an electrostatic separator, comprising:
a plurality of precipitation electrodes formed as lamellar plates having a lower end and an impact side;
a horizontal rapping rod constructed as a ladder-like frame having cross members in form of anvils, said frame guiding the lower ends of the precipitation electrodes, with a first anvil contacting the impact side of a respective precipitation electrode in a rest position;
a hammer configured for striking the rapping rod from one side, and
an elastic spring element with a predetermined spring constant arranged in a gap formed between the side of each precipitation electrodes facing away from the impact side and a second anvil,
wherein the elastic spring element is connected exclusively either with the precipitation electrode on the side facing away from the impact side or with the second anvil so as to enable substantially unimpeded oscillation of the precipitation electrode between the first and second anvils and to return the precipitation electrode to a rest position after the oscillation has decayed.

9. The rapping device of claim 1, wherein the spring element is a substantially V-shaped leaf spring having two legs that enclose an angle.

10. The rapping device of claim 9, wherein one of the two legs is curved and the other leg is straight.

11. The rapping device of claim 10, wherein in the rest position the curved leg contacts the precipitation electrode under spring tension and the straight leg contacts the second anvil.

12. The rapping device of claim 8, wherein the spring element is connected with the second anvil.

13. The rapping device of claim 12, wherein the spring element is clipped on the second anvil.

14. The rapping device of claim 10, wherein the spring element is clipped on the second anvil and a free end of the straight leg has an angled leg portion which clasps an edge face of the second anvil.
